(19) United States
(12) Patent Application Publication
(10) Pub. No.: US 2026/0166356 A1
(43) Pub. Date: Jun. 18, 2026

(54) Foam Fire-Extinguishing Apparatus

(71) Applicant: Xiamen Liuju IoT Technology Co., Ltd., Xiamen (CN)

(72) Inventor: ChinYi Wang, Xiamen (CN)

(21) Appl. No.: 19/418,919

(22) Filed: Dec. 13, 2025

(30) Foreign Application Priority Data
Dec. 13, 2024 (CN) 202423089413.X

(51) Int. Cl. A62C 25/00; A62C 5/02

(52) U.S. Cl. CPC A62C 25/00; A62C 5/02

(57) ABSTRACT

A foam fire-extinguishing apparatus including a housing, and a water pump, a peristaltic pump, a foam concentrate tank, and an air compressor disposed within the housing. The foam concentrate tank and the peristaltic pump are connected via piping to an inlet end of the water pump, and the air compressor is connected via piping to an outlet end of the water pump. The inlet end of the water pump is further provided with a water-supply pipeline arranged in parallel with the foam concentrate tank, and the outlet end of the water pump is configured for connection to an external fire-fighting hose. The foam concentrate tank and the peristaltic pump are laterally docked on the same side of the water pump, while the air compressor is laterally docked on the opposite side.

### CROSS REFERENCE OF RELATED APPLICATIONS

This application claims foreign priority of Chinese Patent Application No. 202423089413.X, filed on 13 Dec. 2024 in the China National Intellectual Property Administration (CNIPA), the entire contents of which are hereby incorporated by reference in their entireties.

### TECHNICAL FIELD

The present invention relates to the field of fire-extinguishing technology, and more particularly to a foam fire-extinguishing apparatus.

### BACKGROUND

Foam fire-extinguishing apparatuses are formulated from hydrocarbons and other components, and can form a dense foam layer on a fuel surface to isolate oxygen, thereby rapidly spreading and achieving fast fire suppression. Existing foam fire-extinguishing apparatuses are typically equipped with a water pump to ensure sufficient inlet and outlet pressure. The pump pressurizes an external water source and delivers it for compression and foaming, thereby improving extinguishing performance. In actual use, by adjusting water intake and pressure, when a fire occurs, the operator opens the foam supply and water supply and activates the pump. Foam is injected into the water at a predetermined ratio to form a mixed foam solution, which is then discharged through an outlet pipe for fire suppression.

As a result, conventional foam fire-extinguishing equipment tends to be bulky, making transportation and carrying inconvenient and limiting the applicable range of use. Particularly in application scenarios such as logistics parks or locations with frequent lithium-battery fires, traditional foam-based fire suppression requires additional pumps and internal components, which is unfavorable for compact installation and adaptation of the overall machine, thereby significantly affecting the efficiency of fire-extinguishing operations.

### SUMMARY

In view of the foregoing, an objective of the present invention is to provide a foam fire-extinguishing apparatus to address the above-mentioned issues.

The present invention adopts the following technical solution:

The present application provides a foam fire-extinguishing apparatus comprising a housing, and a water pump, a peristaltic pump, a foam concentrate tank, and an air compressor disposed within the housing. The foam concentrate tank and the peristaltic pump are connected via piping to an inlet end of the water pump. The air compressor is connected via piping to an outlet end of the water pump. The inlet end of the water pump is further provided with a water-supply pipeline arranged in parallel with the foam concentrate tank. The outlet end of the water pump is configured for connection to an external fire-fighting hose. The foam concentrate tank and the peristaltic pump are laterally disposed and docked on one side of the water pump, while the air compressor is laterally disposed and docked on the opposite side of the water pump.

In a further improvement, a tee pipe is provided at the inlet end of the water pump, and the peristaltic pump is connected to one end of the tee pipe through a liquid-discharge pipe.

In a further improvement, the foam concentrate tank is arranged in parallel on a front side of the peristaltic pump, and the foam concentrate tank is connected to the peristaltic pump through a liquid-intake pipe.

In a further improvement, the peristaltic pump, the water pump, and the tee pipe are arranged side by side, and the peristaltic pump and the tee pipe are disposed opposite each other on two sides of the water pump. The tee pipe is connected to the water-supply pipeline.

In a further improvement, the water-supply pipeline is configured as a water-storage bag placed within the housing and/or an inlet connector at least partially exposed outside the housing.

In a further improvement, the outlet end of the water pump is provided with a water outlet connector and an adapter pipe connected to the water outlet connector. The adapter pipe is fastened and mounted within a window formed in the housing by means of a fixing plate. The adapter pipe is detachably connectable to a fire-fighting hose.

In a further improvement, the apparatus further comprises a control circuit board and a battery assembly. The control circuit board is electrically connected to the battery assembly, and the foam concentrate tank is directly disposed on the battery assembly.

In a further improvement, an internal corner of the housing defines a battery compartment, the battery compartment having an open upper side. The battery assembly is adapted to be accommodated within the battery compartment. When the battery assembly undergoes spontaneous combustion, the outer shell of the foam concentrate tank melts upon heating, allowing the foam concentrate contained therein to flow through the upper opening into the battery compartment to perform active fire suppression.

In a further improvement, the apparatus further comprises a control panel. The control panel is electrically connected to the control circuit board and is disposed on a side of the housing. The control panel at least includes a display, a control switch, and a charging interface.

In a further improvement, the housing comprises a box body having a top opening and a cover removably mounted on the box body. The cover is provided with two handles and a liquid-filling port that is openable and exposes the foam concentrate tank.

By adopting the foregoing technical solution, the present invention achieves the following technical effects:
(1) In the foam fire-extinguishing apparatus of the present application, the foam concentrate tank, peristaltic pump, water pump, and air compressor are arranged in a laterally docked configuration, allowing the structural modules to be unified and concentrated within the housing. This reduces overall equipment size and space occupation, rendering the apparatus more compact and lightweight, and thereby facilitating transportation and on-site use.
(2) The foam concentrate tank precisely controls the flow of concentrate through the peristaltic pump, which is connected to the inlet end of the water pump to achieve efficient mixing of the foam concentrate with the water source. The air compressor pressurizes the outlet end of the water pump so that the mixed solution is discharged as an adhesive, high-coverage foam mixture, significantly improving fire-extinguishing efficiency.
(3) The inlet end of the water pump is arranged in a parallel configuration, allowing connection to the foam concentrate tank for liquid supply while also enabling connection to an external water source or an integrated water source via the water-supply pipeline. This allows the apparatus to flexibly adapt to various water-supply conditions, thereby expanding its range of applications.
(4) By disposing the foam concentrate tank and peristaltic pump in a laterally docked manner on one side of the water pump, and the air compressor in a laterally docked manner on the opposite side, the inlet and outlet layout of the apparatus is more clearly defined. This facilitates independent disassembly and maintenance of each structural module.
(5) The foam fire-extinguishing apparatus is overall more miniaturized, making it particularly suitable for application scenarios such as logistics parks and lithium-battery fire incidents where rapid deployment and limited space are critical. Users can complete equipment connection and startup within a short time, enabling more efficient response to fire emergencies.

### BRIEF DESCRIPTION OF THE DRAWINGS

FIG. 1 is an application scenario diagram of the foam fire-extinguishing apparatus according to an embodiment of the present invention.

FIG. 2 is an exploded schematic view of the foam fire-extinguishing apparatus according to an embodiment of the present invention.

FIG. 3 is a sectional view of the foam fire-extinguishing apparatus according to an embodiment of the present invention.

FIG. 4 is a partial disassembly schematic view of the foam fire-extinguishing apparatus according to an embodiment of the present invention.

FIG. 5 is a schematic diagram illustrating the operating principle of the foam fire-extinguishing apparatus according to an embodiment of the present invention.

FIG. 6 is a structural block diagram of the foam fire-extinguishing apparatus according to an embodiment of the present invention.

Reference numerals: 1—housing; 2—water pump; 3—peristaltic pump; 4—foam concentrate tank; 5—air compressor; 6—tee pipe; 7—liquid-discharge pipe; 8—liquid-intake pipe; 9—water inlet connector; 10—water outlet connector; 11—adapter pipe; 12—fixing plate; 13—window; 14—control circuit board; 15—battery assembly; 16—battery compartment; 17—control panel; 18—display; 19—control switch; 20—charging interface; 21—box body; 22—cover; 23—handle; 24—liquid-filling port; A—fire-fighting hose.

### DETAILED DESCRIPTION OF THE EMBODIMENTS

To make the objectives, technical solutions, and advantages of the embodiments of the present invention clearer, the embodiments are described below in detail with reference to the accompanying drawings. It is apparent that the embodiments described herein constitute only part of the embodiments of the present invention and not all embodiments. Based on the embodiments of the present invention, all other embodiments obtained by those skilled in the art without inventive effort fall within the scope of protection of the present invention. Therefore, the detailed description of the embodiments provided in the drawings is not intended to limit the scope of the claimed invention, but merely illustrates selected embodiments.

### Embodiments

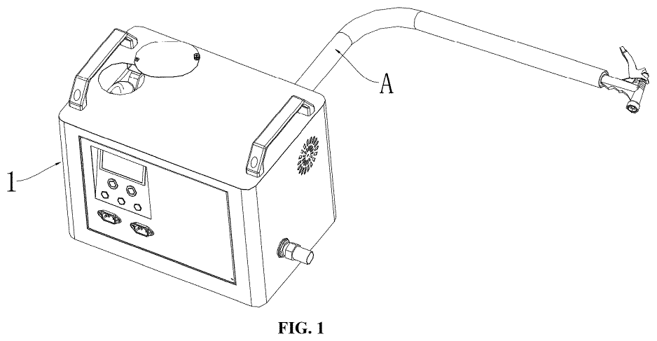

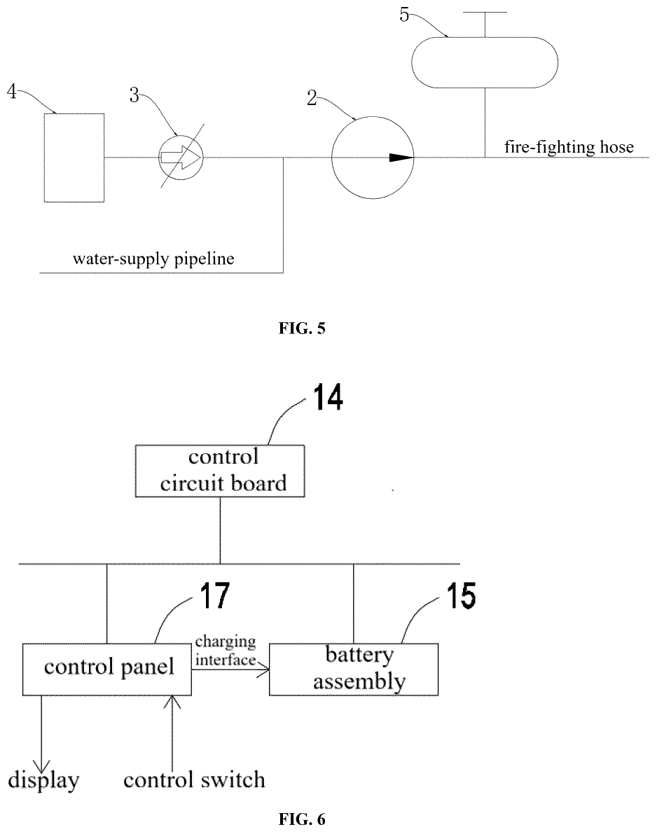

Referring to FIGS. 1-6, the present embodiment provides a foam fire-extinguishing apparatus comprising a housing 1, and a water pump 2, a peristaltic pump 3, a foam concentrate tank 4, and an air compressor 5 disposed within the housing 1. The foam concentrate tank 4 and the peristaltic pump 3 are connected via piping to an inlet end of the water pump 2, and the air compressor 5 is connected via piping to an outlet end of the water pump 2. The inlet end of the water pump 2 is further provided with a water-supply pipeline arranged in parallel with the foam concentrate tank 4. The outlet end of the water pump 2 is configured for connection to an external fire-fighting hose A. The foam concentrate tank 4 and the peristaltic pump 3 are laterally disposed and docked on the same side of the water pump 2, while the air compressor 5 is laterally disposed and docked on the opposite side of the water pump 2.

In the above-described foam fire-extinguishing apparatus, with the water pump 2 serving as the central component, the foam concentrate tank 4 and the peristaltic pump 3 are laterally docked on one side, the water-supply pipeline is laterally docked on another side, and the air compressor 5 together with the outlet-end piping is laterally docked on yet another side. This arrangement allows the structural modules to be regularly distributed around the water pump 2, rendering the inlet and outlet layout of the apparatus clearer and facilitating independent disassembly and maintenance of each module. Moreover, by adopting a laterally docked arrangement for the foam concentrate tank 4, peristaltic pump 3, water pump 2, and air compressor 5, the structural modules are unified and concentrated within the housing 1, reducing the overall volume and footprint of the apparatus and making the machine more compact and lightweight, thereby improving transportability and suitability for on-site operation.

Additionally, by employing a laterally docked configuration in which the structural modules are arranged within the same horizontal plane, the height of the housing 1 can be minimized. As a result, the apparatus has a flatter profile, making it easy for users to carry and relocate at any time, and also allowing it to function as a placement platform within a workspace.

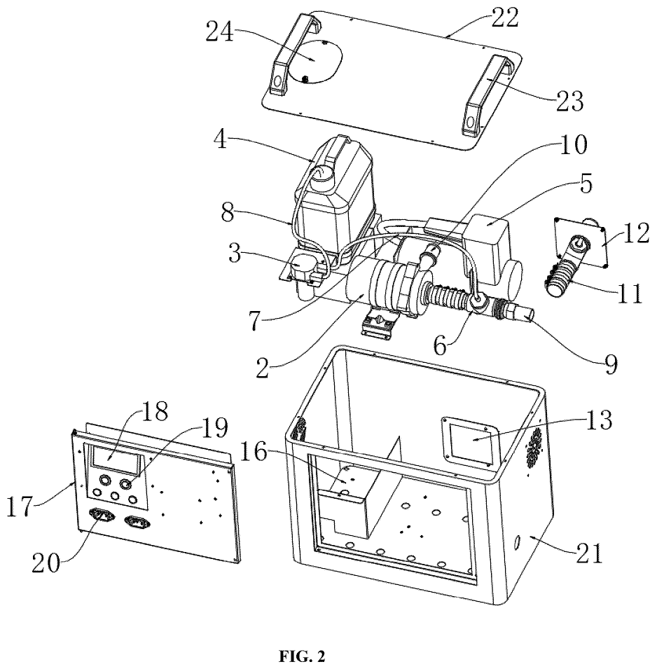

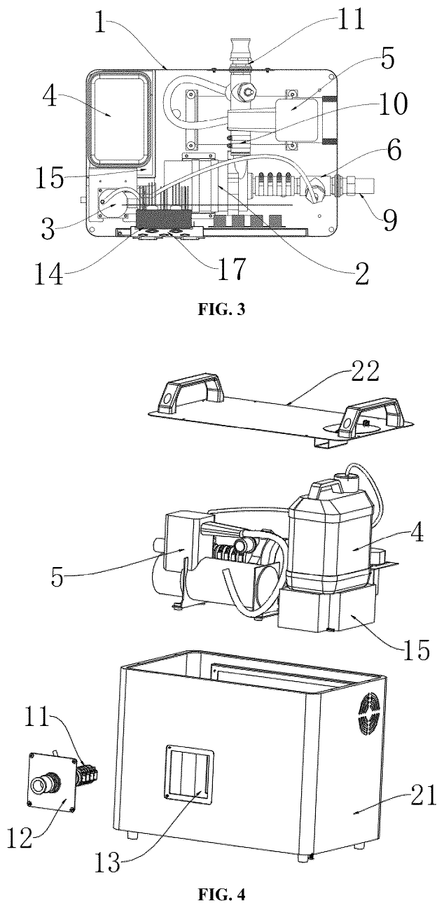

As shown in FIGS. 2 and 3, in the present embodiment, a tee pipe 6 is provided at the inlet end of the water pump 2, and the peristaltic pump 3 is connected to one end of the tee pipe 6 via a liquid-discharge pipe 7. The tee pipe 6 enables direct docking of the supply path from the peristaltic pump 3 and foam concentrate tank 4 to the inlet end of the water pump 2, thereby avoiding complicated piping connections and reducing fluid transmission loss. This enhances both the efficiency and accuracy of mixing the foam concentrate with the water source. In addition, the tee pipe 6 is easier to assemble and disassemble, making installation and maintenance more convenient and efficient. The direct connection between the peristaltic pump 3 and the tee pipe 6 via the liquid-discharge pipe 7 further reduces system complexity and facilitates inspection and repair.

Furthermore, the foam concentrate tank 4 is arranged in parallel on the front side of the peristaltic pump 3, and the foam concentrate tank 4 is connected to the peristaltic pump 3 through a liquid-intake pipe 8. In this manner, the foam concentrate tank 4 and the peristaltic pump 3, which are located on the same side, are arranged in parallel, reducing structural stacking within the apparatus and optimizing spatial utilization inside the housing 1. This compact design makes the overall apparatus smaller and easier to carry and transport. Additionally, by directly connecting the foam concentrate tank 4 to the peristaltic pump 3 via the liquid-intake pipe 8, the liquid transfer path is shortened, reducing flow resistance and loss, ensuring smoother supply of foam concentrate, and further enhancing mixing efficiency.

The peristaltic pump 3, the water pump 2, and the tee pipe 6 are disposed side by side, with the peristaltic pump 3 and the tee pipe 6 respectively positioned on opposite sides of the water pump 2. The tee pipe 6 is connected to the water-supply pipeline. By symmetrically arranging the peristaltic pump 3 and the tee pipe 6 on the two sides of the water pump 2, the water source and foam concentrate are assigned to different sides, thereby clearly distinguishing the water supply from the concentrate supply. The symmetrical configuration effectively balances the weight distribution of the apparatus, enhancing overall stability and facilitating movement and deployment, particularly in uneven or confined fire scenes. The side-by-side arrangement of the components ensures that all core parts are clearly positioned and easy to access.

In one embodiment, the water-supply pipeline is configured as a water-storage bag (not shown) disposed within the housing 1. The water-storage bag serves directly as the water source for the apparatus, enabling foam fire-extinguishing operations without the need for an external water supply, thereby greatly compensating for situations where no water source is available at a fire site. Furthermore, as a self-contained water source, the water-storage bag can be conveniently replenished at any time.

In another embodiment, the water-supply pipeline is configured as a water inlet connector 9 that is at least partially exposed outside the housing 1 (as shown in FIGS. 2 and 3). The water inlet connector 9 is used for direct external connection to a water line to supply water for fire-extinguishing operations.

Preferably, the water-supply pipeline is provided with both a water-storage bag and the water inlet connector 9, arranged in parallel and docked to the water pump 2, thereby allowing selective use of either water source.

As shown in FIGS. 2 and 3, in the present embodiment, the outlet end of the water pump 2 is provided with a water outlet connector 10 and an adapter pipe 11 connected thereto. The adapter pipe 11 is fastened within a window 13 formed in the housing 1 by means of a fixing plate 12. The adapter pipe 11 is detachably connectable to the fire-fighting hose A. On one hand, the detachable connection between the adapter pipe 11 and the fire-fighting hose A enables rapid installation or replacement of the hose during use, enhancing operational flexibility and accommodating hoses of various lengths or specifications, thus facilitating quick deployment across diverse fire scenarios. On the other hand, fastening the adapter pipe 11 to the window 13 of the housing 1 via the fixing plate 12 ensures stable piping connections, preventing loosening or detachment due to pressure fluctuations or external forces, thereby improving the safety and reliability of the apparatus during operation.

As shown in FIGS. 3 and 6, in the present embodiment, the foam fire-extinguishing apparatus further includes a control circuit board 14 and a battery assembly 15. The control circuit board 14 is electrically connected to the battery assembly 15, and the foam concentrate tank 4 is directly disposed on the battery assembly 15.

Specifically, an internal corner of the housing 1 defines a battery compartment 16, the battery compartment 16 having an upper opening. The battery assembly 15 is adapted to be accommodated within the battery compartment 16. When the battery assembly 15 undergoes spontaneous combustion, the outer shell of the foam concentrate tank 4 melts due to heat, allowing the foam concentrate contained therein to flow through the upper opening into the battery compartment 16 for active fire suppression. Thus, by directly mounting the foam concentrate tank 4 above the battery assembly 15, when the battery assembly 15 ignites or overheats, the corresponding outer shell (e.g., resin or plastic) of the foam concentrate tank 4 dissolves, enabling the foam concentrate to flow out and enter the battery compartment 16 through the upper opening to rapidly cool and extinguish the fire, thereby providing significant active protection.

It should be understood that current fire-extinguishing equipment typically uses a battery assembly as its power source. Diesel engines are difficult to maintain and often malfunction when urgently needed, and their large volume is not conducive to compact installation. Additionally, at fire-rescue sites, mains electricity is usually completely shut off to prevent electric shock to firefighters. Therefore, to address temporary power-supply needs, in the present embodiment, a self-contained battery assembly 15 is additionally provided within the battery compartment 16 of the housing 1 to ensure normal electrical operation of the apparatus. Moreover, to prevent combustion of the battery within the housing 1, the foam concentrate tank 4 is directly placed on the battery assembly 15 so that, in the event of battery ignition, the outer shell of the foam concentrate tank 4 dissolves immediately, allowing the foam concentrate to flow out and achieve active fire suppression.

The foam fire-extinguishing apparatus further comprises a control panel 17. The control panel 17 is electrically connected to the control circuit board 14 and is disposed on one side of the housing 1. The control panel 17 includes at least a display 18, a control switch 19, and a charging interface 20. The charging interface 20 is used for connection to an external power source for charging the internal battery assembly 15. The control switch 19 includes multiple switches configured to respectively control the operation and shutoff of the water pump 2, the peristaltic pump 3, and the air compressor 5. Specifically, the control switch 19 further includes functional buttons such as one-touch startup and emergency shutdown, enabling the entire apparatus to be activated or deactivated in response to various emergency situations.

As shown in FIGS. 2 and 4, in the present embodiment, the housing 1 includes a box body 21 having a top opening, and a cover 22 removably mounted on the box body 21. Two handles 23 are provided on the cover 22, along with a liquid-filling port 24 that is openable and exposes the foam concentrate tank 4. The two handles 23 are respectively disposed on the left and right sides to facilitate lifting and transporting the apparatus. The liquid-filling port 24 may be opened via a plug or a flip cover (as shown in FIG. 1), enabling rapid replenishment of the foam concentrate.

The foregoing embodiments are merely preferred embodiments of the present invention. The scope of protection of the present invention is not limited to the above embodiments. Any technical solutions falling within the concept of the present invention shall fall within its scope of protection.

What is claimed is:

1. A foam fire-extinguishing apparatus, comprising a housing, and a water pump, a peristaltic pump, a foam concentrate tank, and an air compressor disposed within the housing; wherein the foam concentrate tank and the peristaltic pump are connected via piping to an inlet end of the water pump, the air compressor is connected via piping to an outlet end of the water pump, and the inlet end of the water pump is further provided with a water-supply pipeline arranged in parallel with the foam concentrate tank; the outlet end of the water pump being configured for connection to an external fire-fighting hose; the foam concentrate tank and the peristaltic pump being laterally docked on the same side of the water pump, and the air compressor being laterally docked on the opposite side of the water pump.

2. The foam fire-extinguishing apparatus according to claim 1, wherein a tee pipe is provided at the inlet end of the water pump, and the peristaltic pump is connected to one end of the tee pipe through a liquid-discharge pipe.

3. The foam fire-extinguishing apparatus according to claim 2, wherein the foam concentrate tank is arranged in parallel on a front side of the peristaltic pump, and the foam concentrate tank is connected to the peristaltic pump through a liquid-intake pipe.

4. The foam fire-extinguishing apparatus according to claim 2, wherein the peristaltic pump, the water pump, and the tee pipe are arranged side by side, and the peristaltic pump and the tee pipe are disposed opposite each other on two sides of the water pump, the tee pipe being connected to the water-supply pipeline.

5. The foam fire-extinguishing apparatus according to claim 4, wherein the water-supply pipeline is configured as a water-storage bag disposed within the housing and/or a water inlet connector at least partially exposed outside the housing.

6. The foam fire-extinguishing apparatus according to claim 2, wherein the outlet end of the water pump is provided with a water outlet connector and an adapter pipe connected thereto, the adapter pipe being fastened within a window formed in the housing by means of a fixing plate, and the adapter pipe being detachably connectable to a fire-fighting hose.

7. The foam fire-extinguishing apparatus according to claim 1, further comprising a control circuit board and a battery assembly; the control circuit board being electrically connected to the battery assembly, and the foam concentrate tank being directly disposed on the battery assembly.

8. The foam fire-extinguishing apparatus according to claim 7, wherein an internal corner of the housing defines a battery compartment having an upper opening, the battery assembly being adapted to be accommodated within the battery compartment;
and when the battery assembly undergoes spontaneous combustion, an outer shell of the foam concentrate tank melts upon heating, allowing foam concentrate contained therein to flow through the upper opening into the battery compartment for active fire suppression.

9. The foam fire-extinguishing apparatus according to claim 7, further comprising a control panel; the control panel being electrically connected to the control circuit board and disposed on a side of the housing; the control panel at least comprising a display, a control switch, and a charging interface.

10. The foam fire-extinguishing apparatus according to claim 1, wherein the housing comprises a box body having a top opening and a cover removably mounted on the box body; the cover being provided with two handles and a liquid-filling port that is openable and exposes the foam concentrate tank.
